(19) United States
(12) Patent Application Publication
(10) Pub. No.: US 2015/0343498 A1
(43) Pub. Date: Dec. 3, 2015

(54) A METHOD AND APPARATUS FOR CLEANING A WORKPIECE USING ULTRASONICS

(71) Applicant: Acden Technologies Ltd., Fort McMurray (CA)

(72) Inventor: Byron KIESER, Beeton (CA)

(21) Appl. No.: 14/347,054

(22) PCT Filed: Feb. 14, 2014
(86) PCT No.: PCT/CA2014/050107

§ 371 Date: Mar. 25, 2014

Related U.S. Application Data
(60) Provisional application No. 61/764,987, filed on Feb. 14, 2013.

(51) Int. Cl. B08B 3/12

(52) U.S. Cl. CPC B08B 3/12

(57) ABSTRACT

There is provided a method of ultrasonically cleaning a workpiece, the method having the steps of providing a cleaning vessel being at least partially filled with a cleaning fluid and having a series of transducers mounted to couple sonic energy into the cleaning fluid, placing the workpiece within the cleaning vessel such that at least a portion of the workpiece is submerged in the cleaning fluid, supporting the workpiece on a set of rollers by one or more rounded surfaces of the workpiece, operating the transducers to transmit sonic energy to the workpiece through the cleaning fluid, the sonic energy being sufficient to clean debris attached to the workpiece, and rotating the workpiece on the set of rollers within the cleaning vessel.

### FIELD

This relates to cleaning a workpiece using ultrasonics.

### BACKGROUND

It is known to clean workpieces submerged in a cleaning fluid with the use of ultrasonics. PCT publication no. WO 2011/075831 (Phillips et al.) entitled “Apparatus for Cleaning industrial Components” and PCT publication no. WO 2013/056378 (Tevely et al.) entitled “Method and Apparatus for Cleaning Diesel Particulate Filters” relate to different principles that may be applied to cleaning workpieces using transducers.

### SUMMARY

There is provided a method of ultrasonically cleaning a workpiece, comprising the steps of: providing a cleaning vessel being at least partially filled with a cleaning fluid and having a series of transducers mounted to couple sonic energy into the cleaning fluid; placing the workpiece within the cleaning vessel such that at least a portion of the workpiece is submerged in the cleaning fluid; supporting the workpiece on a set of rollers by one or more rounded surfaces of the workpiece; operating the transducers to transmit sonic energy to the workpiece through the cleaning fluid, the sonic energy being sufficient to clean debris attached to the workpiece; and rotating the workpiece on the set of rollers within the cleaning vessel.

According to an aspect, the workpiece may be a heat exchanger comprising a housing enclosing a set of exchanger tubes.

According to an aspect, the set of rollers may be carried by a skid. The skid may be removed from the cleaning vessel. The skid may comprise a superstructure having lifting attachments. The superstructure may be removed from the skid.

According to an aspect, the workpiece may be oriented horizontally in the cleaning vessel.

According to an aspect, the method may further comprise the step of providing the workpiece with the one or more rounded surfaces prior to supporting the workpiece on the set of rollers.

According to an aspect, the series of transducers may be submerged within the cleaning fluid.

According to another aspect, there is provided an apparatus for cleaning a workpiece. The apparatus comprises a cleaning vessel that is at least partially filled with a cleaning fluid. A plurality of transducers are mounted to the cleaning vessel for coupling sonic energy into the cleaning fluid. A set of rollers is within the cleaning vessel. The set of rollers support a workpiece to be cleaned. A drive source rotates the workpiece on the set of rollers.

According to an aspect, the set of rollers may be arranged to conform to one or more rounded surfaces of the workpiece.

According to an aspect, the set of rollers may he mounted to a skid. The skid may he removable from the cleaning vessel. The skid may comprise a superstructure having lifting attachments. The superstructure may be removable from the skid.

According to an aspect, the set of rollers may comprise at least one roller that is driven by a power source, the set of rollers causing, the workpiece to rotate.

According to an aspect, the transducers may be mounted diagonally within the cleaning vessel.

These and other aspects that will be apparent from the description and claims below may be combined in any reasonable combination.

### BRIEF DESCRIPTION OF THE DRAWINGS

These and other features will become more apparent from the following description in which reference is made to the appended drawings, the drawings are for the purpose of illustration only and are not intended to he in any way limiting, wherein:

FIG. 1 is a partially transparent perspective view of an apparatus for cleaning a workpiece.

FIG. 2 is a perspective view in section of the apparatus.

FIG. 3 is a perspective view of a set of rollers.

FIG. 4 is a perspective view of a set of rollers with a drive mechanism.

FIG. 5 is a perspective view of a skid with rollers.

FIG. 6 is a perspective view of a workpiece on the skid.

FIG. 7 is a perspective view of a skid with a superstructure.

FIG. 8 is an exploded perspective view of the skid and superstructure.

FIG. 9 is a perspective view of an alternative skid and superstructure.

FIG. 10 is an exploded side elevation view of a workpiece.

FIG. 11 is a side elevation view of a workpiece.

FIG. 12 is an end elevation view of a workpiece.

### DETAILED DESCRIPTION

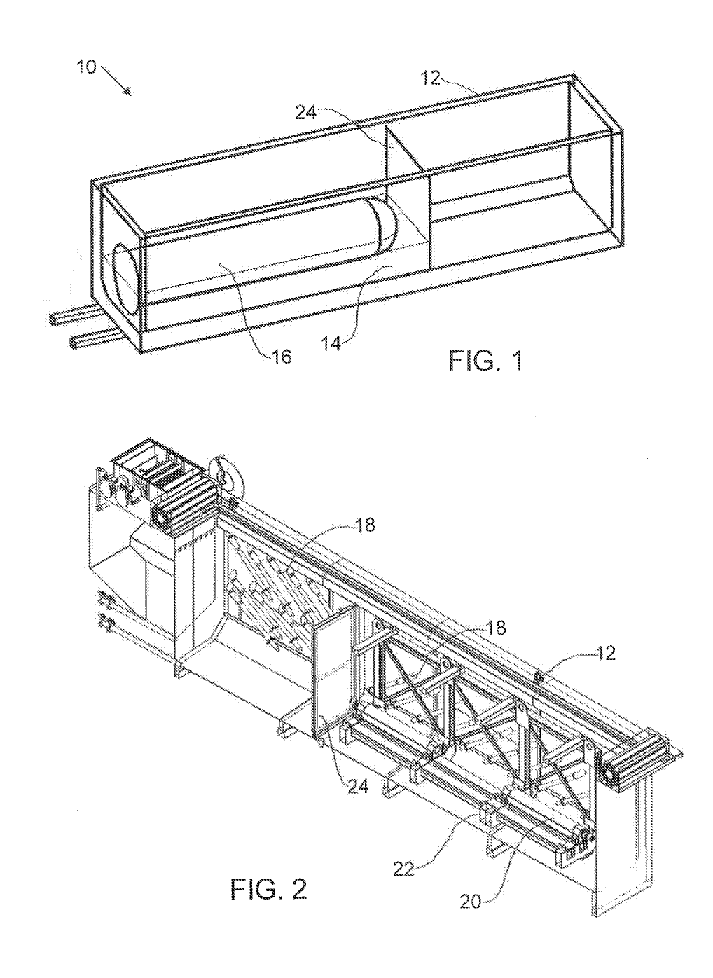

Referring to FIG. 1, there is shown an apparatus, generally indicated by reference numeral 10, for cleaning a workpiece 16. Apparatus 10 includes a cleaning vessel 12 that is at least partially tilled with a cleaning fluid 14. Workpiece 16 to be cleaned is shown partially submerged within cleaning fluid 14. Referring to FIG. 2, a plurality of transducers 18 are mounted to cleaning vessel 12 for coupling sonic energy into cleaning fluid 14. Transducers 18 are preferably attached to the inside of cleaning vessel 12 at a level to be submerged within cleaning fluid 14. Transducers 18 are driven with sufficient power and at a desired frequency to clean workpiece 16. The actual power and frequency, or combination of powers and frequencies that may be used in order to clean workpiece 16 will depend on, for example, the type of workpiece, the type of debris or contaminants to be cleaned, and the client and may be determined by those skilled in the an based principles known in the art.

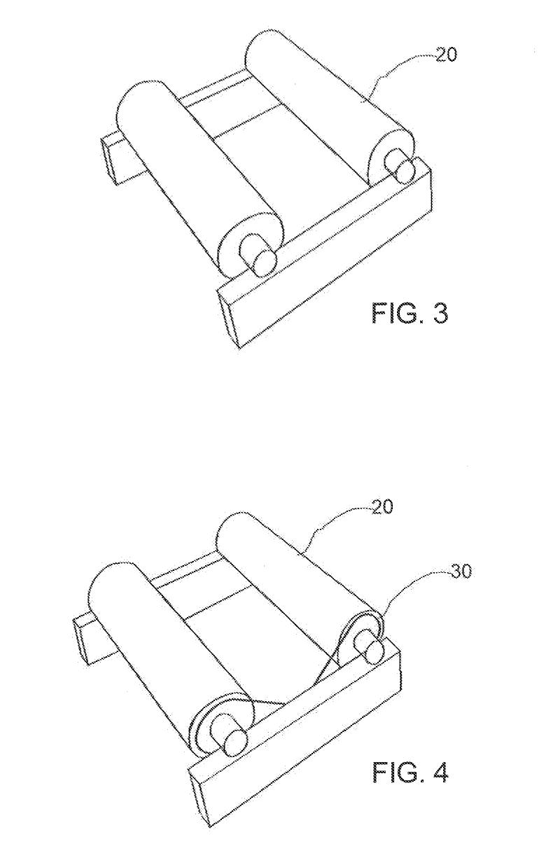

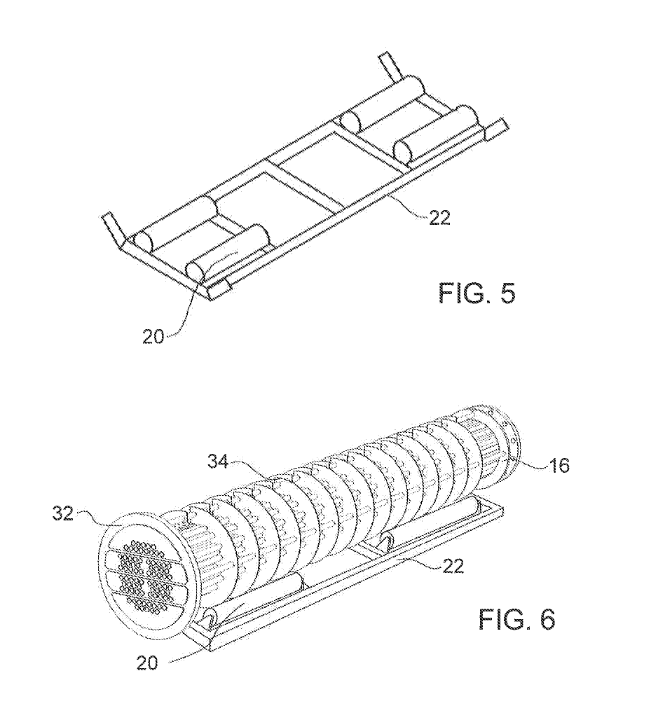

Referring to FIG. 2, apparatus 10 includes a set of rollers 20, an example of which is shown in FIGS. 3 and 4. Rollers 20 may be incorporated into a skid 22, as shown in FIGS. 5 and 6. Preferably, rollers 20 on skid 22 are designed to conform to a rounded surface in order to properly support workpiece 16. Referring to FIGS. 1 and 2, workpiece 16 is positioned in cleaning vessel 12 on rollers 20 and may be partially submerged. In the depicted example, a baffle 24 may be used to effectively shorten vessel 12 and reduce the amount of cleaning fluid 14 required to sufficiently submerge workpiece 16.

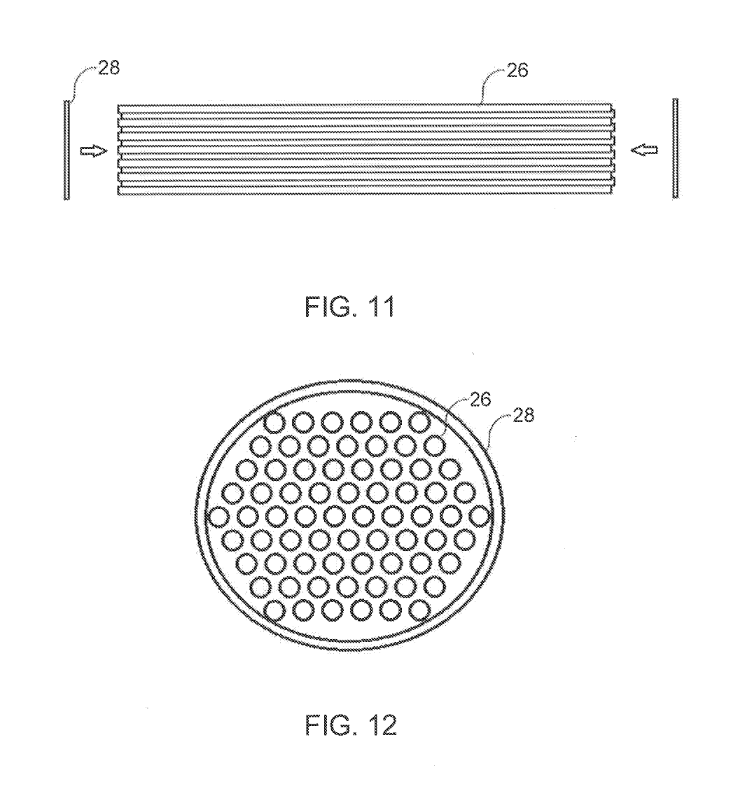

Apparatus 10 is particularly useful in cleaning workpieces such as heat exchangers, which are made up of a series of exchanger tubes. Exchanger tubes are typically enclosed within a housing, but are preferably removed from the housing for cleaning, as shown in FIG. 6. Referring to FIG. 10, there is shown a bundle of exchanger tubes 26. Exchanger tubes in bundle 26 may be straight with an opening at each end of the bundle as shown, or may only have openings at one end in the case of a u-tube exchanger bundle. Bundles 26 may be arranged in a round bundle with one or two end sheets 32 and intermediate baffle plates 34 to support the tubes. While exchanger bundles 26 will often have a round cross section, this may not always be the case, as shown in FIG. 12. Other equipment or workpieces that may he cleaned may also not have a round cross-section. Referring to FIGS. 11 and 12, round collars 28 may be attached that allow objects that are not round to rotate on rollers 20. As will be understood, the portion of workpiece that engages the rollers, either as part of the workpiece, or attached to the workpiece, should be rounded to allow the workpiece to turn on the rollers. Workpiece 16 may be temporarily modified for cleaning purposes if necessary, as has been done in FIG. 12, where collars 28 have been attached to an exchanger bundle 26. In the example depicted in FIG. 4, set of rollers 20 is driven by a chain 30 to cause rollers 20 to turn in order to rotate workpiece 16 in cleaning vessel 12. Other designs for rotating the workpiece may also be used, as will be recognized by those skilled in the art. For example, the rollers may have an integral motor, such as an electric or hydraulic motor, that drives one or more rollers.

By rotating the workpiece in the fluid during cleaning, the ultrasonic waves are swept across the tubes within, more evenly distributing the energy and increasing the cleaning efficiency. The rotation also helps dislodge material from the part because of the motion (changes in attitude) and momentum transfer (moving through the liquid) and liquid exchange rate increase near the surface of the part. The motion should be “slow enough” so as not to significantly agitate the solution internally (disrupt sound waves) or at the surface (gasification). In addition, rod style transducers are preferably mounted diagonally with respect to the tube orientation (which is preferably horizontal) such that the wave nodes sweep across the length of the tubes as they rotate. It has been found that mounting transducers horizontally or vertically will clean the workpiece with less consistency along its length. As the workpiece rotates, this results in “bands” of areas that may be cleaned less or more than others. Other types of transducers or transducer mountings may be used. For example, the mountings may move the transducers relative to the walls of the vessel, such as in a cyclic movement, or in a linear movement with a horizontal and/or vertical component. The position of the transducers may also be adjustable, either automatically or manually within the vessel, such as to adjust for a particular size and shape of a workpiece, or to adjust the cleaning force being applied to the workpiece as the cleaning process progresses. This may be used to distribute the ultrasonic energy more equally along the workpiece. The frequencies and power requirements of the transducers may be optimized by those skilled in the art. The action of the tubes raising and lowering from the fluid also helps to flush the inside of the tubes, where, depending on the exchanger design, the exchanger is preferably mounted on the skid such that it is slightly tilted to one end or the other. The rollers on the skid may be positioned anywhere along the length of the skid to accommodate different length exchangers (and balance the weight) and may be moved vertically to accommodate different end diameters, as well as to allow a slight tilt.

Referring to FIG. 1, the heat exchanger will preferably be submerged at least half way in the tank. In addition, the exchanger tubes within the heat exchanger must be opened to the liquid to allow the cleaning liquid to enter each tube.

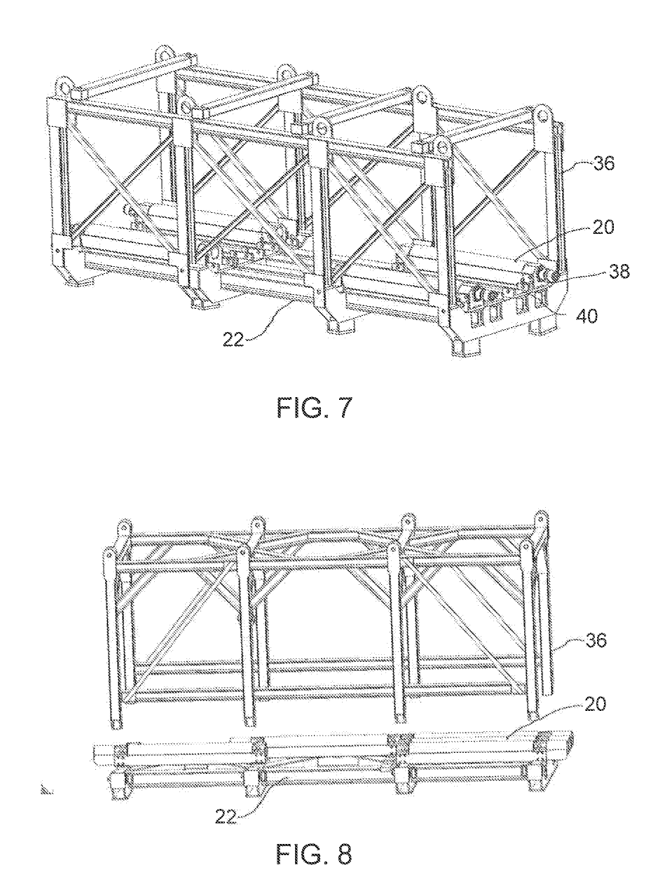

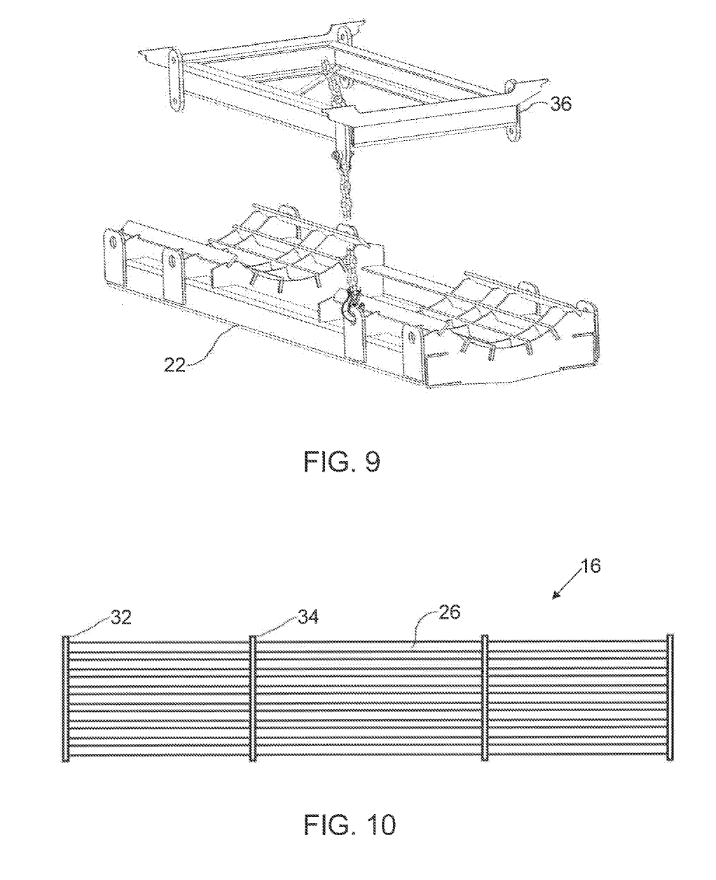

The skid has the added benefit of eliminating slings used typically to raise and lower the exchanger. Referring to FIG. 7-9, preferably, skid 22 has some sort of superstructure 36 used as hoist points for a spreader bar or slings from a crane. Superstructure 36 may be tall enough to extend out of the cleaning fluid in the vessel, or at least extends to a known position, such that superstructure 36 can be more accurately and more easily engaged by a crane or other lifting device. Skid 22 may carry more than one set of rollers spaced along its length or, as can be seen in FIG. 7, superstructure 36 may have more than one position that can carry rollers 20. The outer pockets 38 hold rollers in a position used for larger diameter workpieces, while the inner pockets 40 are useful for smaller diameter workpieces. Superstructure 36 may have upper pieces 42 that are removable to provide access to the rollers 20 from above, such that a crane can be used to manipulate the position of a workpiece. Alternatively, referring to FIGS. 8 and 9, the entire superstructure 36 may be removable from skid 22 to reduce the amount of material and obstacles in the cleaning tank in order to achieve a higher cleaning efficiency. As seen in FIG. 8, superstructure 36 may he a rigid structure, or referring to FIG. 9, it may be attached by chains. Referring to FIG. 7, the bottom of the superstructure 36 or skid 22 may be shaped to engage the bottom of a tank, such that the superstructure 36 or skid 22 may be used in an existing cleaning tank. It will be understood that superstructure 36 and skid 22 may be integrally formed, or may take other shapes aside from those described herein. In one example, the skid may be 30 feet long with a capacity of up to 50 tons.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. The scope of the claims should not be limited by the preferred embodiments set forth in the examples above.

1. A method of ultrasonically cleaning a workpiece, the method comprising the steps of:
providing a cleaning vessel being at least partially filled with a cleaning fluid and having a series of transducers mounted to couple sonic energy into the cleaning fluid;
placing the workpiece within the cleaning vessel such that at least a portion of the workpiece is submerged in the cleaning fluid;
supporting the workpiece on a set of rollers by one or more rounded surfaces of the workpiece;
operating the transducers to transmit sonic energy to the workpiece through the cleaning fluid, the sonic energy being sufficient to clean debris attached to the workpiece; and
rotating the workpiece on the set of rollers within the cleaning vessel.

2. The method of claim 1, wherein the workpiece is a set of exchanger tubes.

3. The method of claim 1, wherein the set of rollers are carried by a skid.

4. The method of claim 3, further comprising the step of removing the skid from the cleaning vessel.

5. The method of claim 3, wherein the skid comprises a superstructure having lifting attachments.

6. The method of claim 5, further comprising the step of removing the superstructure from the skid.

7. The method of claim 1, wherein the workpiece is oriented horizontally in the cleaning vessel.

8. The method of claim 1, further comprising the step of providing the workpiece with the one or more rounded surfaces prior to supporting the workpiece on the set of rollers.

9. The method of claim 1, wherein the series of transducers are submerged within the cleaning fluid.

10. An apparatus for cleaning a workpiece, the apparatus comprising:
a cleaning vessel that is at least partially filled with a cleaning fluid;
a plurality of transducers mounted to the cleaning vessel for coupling sonic energy into the cleaning fluid;
a set of rollers within the cleaning vessel, the set of rollers supporting a workpiece to be cleaned; and
a drive source for rotating the workpiece on the set of rollers.

11. The apparatus of claim 10, wherein the set of rollers are arranged to conform to one or more rounded surfaces of the workpiece.

12. The apparatus of claim 10, wherein the set of rollers is mounted to a skid.

13. The apparatus of claim 11, wherein the skid is removable from the cleaning vessel.

14. The apparatus of claim 11, wherein the skid comprises a superstructure having lifting attachments.

15. The apparatus of claim 13, wherein the superstructure is removable from the skid.

16. The apparatus of claim 10, wherein the set of rollers comprises at least one roller that is driven by a power source, the set of rollers causing the workpiece to rotate.

17. The apparatus of claim 10, wherein the transducers are mounted diagonally within the cleaning vessel.
